(19) United States
(12) Patent Application Publication
(10) Pub. No.: US 2026/0155565 A1
(43) Pub. Date: Jun. 4, 2026

(54) ELECTRONIC DEVICE WITH ANTENNA MODULE

(71) Applicant: MEDIATEK INC., Hsinchu City (TW)

(72) Inventors: Wei-Hsuan CHANG, Hsinchu City (TW); Chih-Wei CHIU, Hsinchu City (TW); Chih-Wei LEE, Hsinchu City (TW)

(21) Appl. No.: 19/372,645

(22) Filed: Oct. 29, 2025

Related U.S. Application Data
(60) Provisional application No. 63/726,678, filed on Dec. 2, 2024.

(51) Int. Cl. H01Q 3/26; H01Q 1/24

(52) U.S. Cl. CPC H01Q 3/2605; H01Q 1/243

(57) ABSTRACT

An electronic device is provided. The electronic device includes an antenna module and a guiding structure. The antenna module includes a plurality of antenna units and a substrate. The antenna units are arranged in a matrix on the substrate. The antenna units include a first antenna unit and a second antenna unit. The first antenna unit transmits a first wireless signal, and the second antenna unit transmits a second wireless signal. The guiding structure is formed with a plurality of guiding through-holes. The guiding through-holes correspond to the respective antenna units, and the guiding through-holes include a first guiding through-hole and a second guiding through-hole. The first guiding through-hole guides the first wireless signal primarily along a first axis, and the second guiding through-hole guides the second wireless signal primarily along a second axis. The first axis and the second axis extend outward from the substrate separately.

### CROSS REFERENCE TO RELATED APPLICATIONS

This application claims the benefit of U.S. Provisional Application No. 63/726,678, filed Dec. 2, 2024, the entirety of which is incorporated by reference herein.

### BACKGROUND OF THE INVENTION

### Field of the Invention

The present invention relates to an electronic device, and, in particular, it relates to an electronic device with an antenna module.

### Description of the Related Art

Existing 5G millimeter-wave technology utilizes the high bandwidth and low latency characteristics of millimeter waves to enable faster data transmission and richer application scenarios on communication devices such as mobile phones. For example, there are known 5G modems and radio frequency systems that support millimeter-wave frequency bands, allowing mobile phones to provide more stable high-speed network connections in densely populated areas (such as stadiums and concert venues), and support higher-definition streaming video, cloud gaming, AR/VR, and other applications. In addition, millimeter-wave technology is also used to improve the positioning accuracy of mobile phones and provide more precise sensing capabilities in specific scenarios. However, the propagation characteristics of millimeter waves also bring challenges, such as weak penetration and susceptibility to blockage. Therefore, existing technologies are also committed to improving the coverage and connection stability of millimeter waves using technologies such as beamforming and antenna arrays.

Regarding 5G millimeter-wave technology, the U.S. Federal Communications Commission (FCC) has established extremely strict and detailed standards for power density (PD) within the near-field radiation zone (approximately 20×20 square millimeters). This standard aims to ensure that users are not harmed by excessive radiation when in close proximity to 5G millimeter-wave devices, thereby protecting human health and safety. Conventionally, manufacturers have often adopted the strategy of reducing near-field radiation power to comply with the near-field power density limits in the FCC regulations, ensuring that the radiation level of the device within the near-field region meets the standard. However, this inevitably leads to a significant decrease in far-field radiation power, which significantly degrades the long-distance communication quality of mobile phones or other 5G millimeter-wave devices. Far-field radiation is crucial for achieving high-speed and stable data transmission in 5G millimeter-wave technology. When the far-field radiation power is insufficient, the signal coverage of the device will be greatly reduced, the transmission rate will be significantly decreased, and even disconnection or unstable signals may occur.

### BRIEF SUMMARY OF THE INVENTION

An embodiment of the present invention provides an electronic device. The electronic device includes an antenna module and a guiding structure. The antenna module includes a plurality of antenna units and a substrate. The antenna units are arranged in a matrix on the substrate. The antenna units include a first antenna unit and a second antenna unit. The first antenna unit transmits a first wireless signal, and the second antenna unit transmits a second wireless signal. The guiding structure is formed with a plurality of guiding through-holes. The guiding through-holes correspond to the respective antenna units, and the guiding through-holes include a first guiding through-hole and a second guiding through-hole. The first guiding through-hole guides the first wireless signal primarily along a first axis, and the second guiding through-hole guides the second wireless signal primarily along a second axis. The first axis and the second axis extend outward from the substrate separately.

In one embodiment, the first axis and the second axis are symmetrical relative to a third axis, and the third axis is perpendicular to the substrate.

In one embodiment, the antenna units further comprise a third antenna unit, the guiding through-holes further comprise a third guiding through-hole, the third antenna unit transmits a third wireless signal, the third guiding through-hole guides the third wireless signal primarily along the third axis, and the third antenna unit is located between the first antenna unit and the second antenna unit.

In one embodiment, the antenna units further comprise a fourth antenna unit, the guiding through-holes further comprise a fourth guiding through-hole, the fourth antenna unit transmits a fourth wireless signal, the fourth guiding through-hole guides the fourth wireless signal primarily along a fourth axis, the first antenna unit is located between the fourth antenna unit and the third antenna unit, a first included angle is formed between the first axis and the third axis, a second included angle is formed between the fourth axis and the third axis, and the second included angle is not smaller than the first included angle.

In one embodiment, the antenna units further comprise a fifth antenna unit, the guiding through-holes further comprise a fifth guiding through-hole, the fifth antenna unit transmits a fifth wireless signal, the fifth guiding through-hole guides the fifth wireless signal primarily along a fifth axis, the second antenna unit is located between the fifth antenna unit and the third antenna unit, a third included angle is formed between the second axis and the third axis, a fourth included angle is formed between the fifth axis and the third axis, and the fourth included angle is not smaller than the third included angle.

In one embodiment, the radiation intensity of the fourth wireless signal is greater than that of the third wireless signal.

In one embodiment, the radiation intensity of the first wireless signal is greater than or equal to that of the third wireless signal.

In one embodiment, the radiation intensity of the fifth wireless signal is greater than that of the third wireless signal.

In one embodiment, the radiation intensity of the second wireless signal is greater than or equal to that of the third wireless signal.

In one embodiment, the electronic device further comprises a controller, wherein the controller is coupled to the antenna module, and the controller determines the radiation intensities of the first wireless signal, the second wireless signal, the fourth wireless signal and the fifth wireless signal in every beamforming configuration based on the power density distribution in the near field of every beamforming configuration.

In one embodiment, the thickness of the guiding structure is between 1.5 mm and 3 mm.

In one embodiment, the electronic device further comprises a device housing, wherein the guiding structure is formed on the device housing.

In one embodiment, a first guiding slope is formed within the first guiding through-hole, and in a vertical projection plane, the first guiding slope partially overlaps the first antenna unit.

In one embodiment, the antenna units further comprise a third antenna unit, the guiding through-holes further comprise a third guiding through-hole, the third antenna unit transmits a third wireless signal, the third guiding through-hole guides the third wireless signal primarily along the third axis, the third antenna unit is located between the first antenna unit and the second antenna unit, a second guiding slope is formed within the second guiding through-hole, and in the vertical projection plane, the second guiding slope partially overlaps the second antenna unit.

Utilizing the electronic device of the embodiment of the invention, the fourth wireless signal and the fifth wireless signal are transmitted outward from the substrate independently, thereby avoiding detection within the near-field radiation zone (approximately 20×20 square millimeters). As a result, during the power density (PD) test conducted within this near-field radiation zone, the radiation intensities primarily detected are those of the first wireless signal S1, the second wireless signal S2, and the third wireless signal S3. Consequently, the radiation level of the electronic device in the near-field region complies with the applicable standards. Furthermore, the far-field radiation power of the electronic device can be enhanced, leading to improved long-distance communication quality.

### BRIEF DESCRIPTION OF THE DRAWINGS

The present invention can be more fully understood by reading the subsequent detailed description and examples with references made to the accompanying drawings, wherein:

FIG. 1 is a perspective view of a portion of the electronic device of the embodiment of the invention;

FIG. 2A shows a guiding structure of an embodiment of the invention;

FIG. 2B shows the guiding structure and an antenna module of the embodiment of the invention;

FIG. 3 is a block diagram of the electronic device of the embodiment of the invention;

FIG. 4 shows a guiding structure of another embodiment of the invention; and

FIG. 5 shows the guiding slopes of the embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

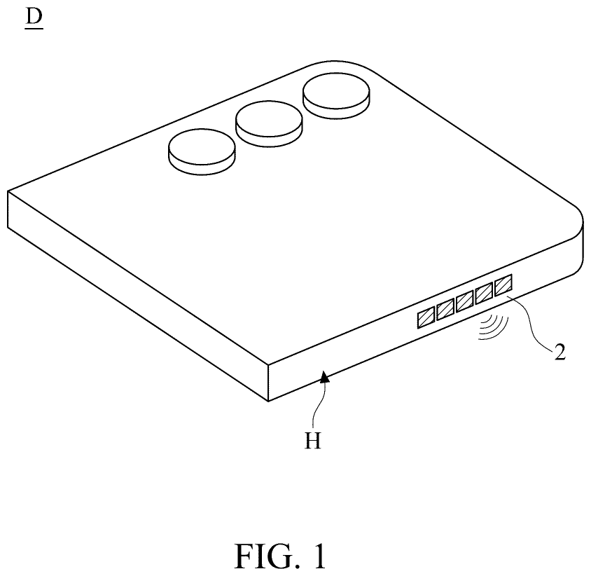

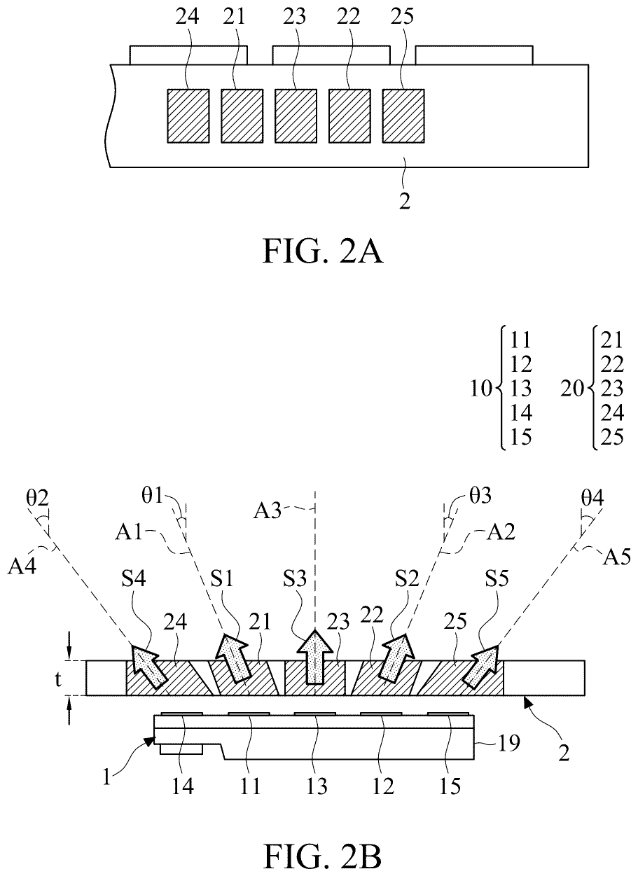

FIG. 1 is a perspective view of a portion of the electronic device of the embodiment of the invention. FIG. 2A shows a guiding structure of an embodiment of the invention. FIG. 2B shows the guiding structure and an antenna module of the embodiment of the invention. With reference to FIGS. 1, 2A and 2B, the electronic device D of the embodiment of the invention includes an antenna module 1 and a guiding structure 2. The antenna module 1 includes a plurality of antenna units 10 and a substrate 19. The antenna units 10 are arranged in a matrix on the substrate 19. The antenna units 1 include a first antenna unit 11 and a second antenna unit 12. The first antenna unit 11 transmits a first wireless signal S1, and the second antenna unit 12 transmits a second wireless signal S2. The guiding structure 2 is formed with a plurality of guiding through-holes 20. The guiding through-holes 20 correspond to the respective antenna units 10. The guiding through-holes 20 include a first guiding through-hole 21 and a second guiding through-hole 22. The first guiding through-hole 21 guides the first wireless signal S1 primarily along a first axis A1. The second guiding through-hole 22 guides the second wireless signal S2 primarily along a second axis A2. The first axis A1 and the second axis A2 extend outward from the substrate 19 separately.

With reference to FIGS. 2A and 2B, in one embodiment, the first axis A1 and the second axis A2 are symmetrical relative to a third axis A3, and the third axis A3 is perpendicular to the substrate 19.

With reference to FIGS. 2A and 2B, in one embodiment, the antenna units 10 further comprise a third antenna unit 13. The guiding through-holes 20 further comprise a third guiding through-hole 23. The third antenna unit 13 transmits a third wireless signal S3. The third guiding through-hole 23 guides the third wireless signal S3 primarily along the third axis A3. The third antenna unit 13 is located between the first antenna unit 11 and the second antenna unit 12.

With reference to FIGS. 2A and 2B, in one embodiment, the antenna units 10 further comprise a fourth antenna unit 14. The guiding through-holes 20 further comprise a fourth guiding through-hole 24. The fourth antenna unit 14 transmits a fourth wireless signal S4. The fourth guiding through-hole 24 guides the fourth wireless signal S4 primarily along a fourth axis A4. The first antenna unit 11 is located between the fourth antenna unit 14 and the third antenna unit 13. A first included angle θ1 is formed between the first axis A1 and the third axis A3. The first included angle θ1 is greater than zero. In one embodiment, the first included angle θ1 is smaller than or equal to 60 degrees. A second included angle θ2 is formed between the fourth axis A4 and the third axis A3, and the second included angle θ2 is not smaller than the first included angle θ1.

With reference to FIGS. 2A and 2B, in one embodiment, the antenna units 10 further comprise a fifth antenna unit 15. The guiding through-holes 20 further comprise a fifth guiding through-hole 25. The fifth antenna unit 15 transmits a fifth wireless signal S5. The fifth guiding through-hole 25 guides the fifth wireless signal S5 primarily along a fifth axis A5. The second antenna unit 12 is located between the fifth antenna unit 15 and the third antenna unit 13. A third included angle θ3 is formed between the second axis A2 and the third axis A3. The third included angle θ3 is greater than zero. In one embodiment, the third included angle θ3 is smaller than or equal to 60 degrees. A fourth included angle θ4 is formed between the fifth axis A5 and the third axis A3. The fourth included angle θ4 is not smaller than the third included angle θ3.

With reference to FIG. 2B, in one embodiment, the radiation intensity of the fourth wireless signal S4 is greater than that of the third wireless signal S3.

With reference to FIG. 2B, in one embodiment, the radiation intensity of the first wireless signal S1 is greater than or equal to that of the third wireless signal S3.

With reference to FIG. 2B, in one embodiment, the radiation intensity of the fifth wireless signal S5 is greater than that of the third wireless signal S3.

With reference to FIG. 2B, in one embodiment, the radiation intensity of the second wireless signal S2 is greater than or equal to that of the third wireless signal S3.

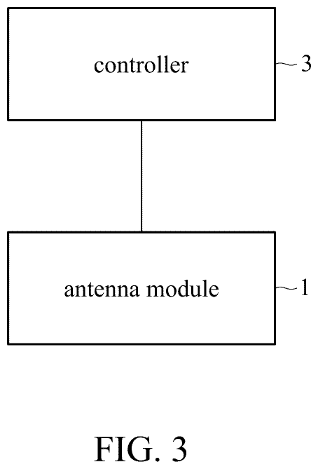

FIG. 3 is a block diagram of the electronic device of the embodiment of the invention. With reference to FIGS. 2B and 3, in one embodiment, the electronic device further comprises a controller 3, wherein the controller 3 is coupled to the antenna module 1, and the controller 3 determines the radiation intensities of the first wireless signal S1, the second wireless signal S2, the fourth wireless signal S4 and the fifth wireless signal S5 in every beamforming configuration based on the power density distribution in the near field of every beamforming configuration. For example, in one embodiment, the ratios of the radiation intensities of the first wireless signal S1, the second wireless signal S2, the third wireless signal S3, the fourth wireless signal S4 and the fifth wireless signal S5 can be 3:2:1:1:1. In another embodiment, the ratios of the radiation intensities of the first wireless signal S1, the second wireless signal S2, the third wireless signal S3, the fourth wireless signal S4 and the fifth wireless signal S5 can be 3:2:1:2:3. In further another embodiment, the ratios of the radiation intensities of the first wireless signal S1, the second wireless signal S2, the third wireless signal S3, the fourth wireless signal S4 and the fifth wireless signal S5 can be 3:2:1:1:2.

With reference to FIG. 2B, in one embodiment, the thickness t of the guiding structure 2 is between 1.5 mm and 3 mm. The disclosure is not meant to restrict the invention.

With reference to FIG. 1, in one embodiment, the electronic device D further comprises a device housing H, wherein the guiding structure 2 is formed on the device housing H. In one embodiment, the guiding structure 2 can be a metal structure. The disclosure is not meant to restrict the invention.

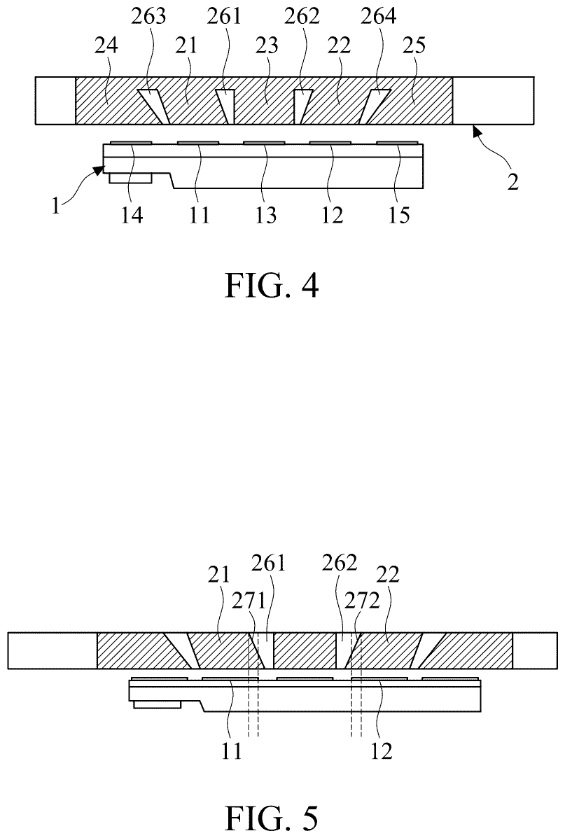

FIG. 4 shows a guiding structure of another embodiment of the invention. With reference to FIG. 4, in one embodiment, the guiding structure 2 includes a first guiding wall 261, a second guiding wall 262, a third guiding wall 263 and a fourth guiding wall 264. The first guiding wall 261 is formed between the first guiding through-hole 21 and the third guiding through-hole 23. The second guiding wall 262 is formed between the second guiding through-hole 22 and the third guiding through-hole 23. The third guiding wall 263 is formed between the first guiding through-hole 21 and the fourth guiding through-hole 24. The fourth guiding wall 264 is formed between the second guiding through-hole 22 and the fifth guiding through-hole 25. The height of the tops of the first guiding wall 261, the second guiding wall 262, the third guiding wall 263 and the fourth guiding wall 264 can be equal or lower than the height of the outer surface of the device housing. The shape of the guiding walls of the embodiment of the invention can be modified. The disclosure is not meant to restrict the invention.

FIG. 5 shows the guiding slopes of the embodiment of the invention. With reference to FIGS. 1 and 5, in one embodiment, a first guiding slope 271 is formed on the first guiding wall 261 (within the first guiding through-hole 21), and in a vertical projection plane, the first guiding slope 271 partially overlaps the first antenna unit 11. A second guiding slope 272 is formed on the second guiding wall 262 (within the second guiding through-hole 22), and in the vertical projection plane, the second guiding slope 272 partially overlaps the second antenna unit 12. Therefore, the first wireless signal S1 and the second wireless signal S2 can be transmitted outward from the substrate 19 separately.

Utilizing the electronic device of the embodiment of the invention, the fourth wireless signal and the fifth wireless signal are transmitted outward from the substrate independently, thereby avoiding detection within the near-field radiation zone (approximately 20×20 square millimeters). As a result, during the power density (PD) test conducted within this near-field radiation zone, the radiation intensities primarily detected are those of the first wireless signal S1, the second wireless signal S2, and the third wireless signal S3. Consequently, the radiation level of the electronic device in the near-field region complies with the applicable standards. Furthermore, the far-field radiation power of the electronic device can be enhanced, leading to improved long-distance communication quality.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
an antenna module, comprising a plurality of antenna units and a substrate, wherein the antenna units are arranged in a matrix on the substrate, and the antenna units comprise a first antenna unit and a second antenna unit, wherein the first antenna unit transmits a first wireless signal, and the second antenna unit transmits a second wireless signal; and
a guiding structure, formed with a plurality of guiding through-holes, wherein the guiding through-holes correspond to the respective antenna units, and the guiding through-holes comprise a first guiding through-hole and a second guiding through-hole, the first guiding through-hole guides the first wireless signal primarily along a first axis, the second guiding through-hole guides the second wireless signal primarily along a second axis, and the first axis and the second axis extend outward from the substrate separately.

2. The electronic device as claimed in claim 1, wherein the first axis and the second axis are symmetrical relative to a third axis, and the third axis is perpendicular to the substrate.

3. The electronic device as claimed in claim 2, wherein the antenna units further comprise a third antenna unit, the guiding through-holes further comprise a third guiding through-hole, the third antenna unit transmits a third wireless signal, the third guiding through-hole guides the third wireless signal primarily along the third axis, and the third antenna unit is located between the first antenna unit and the second antenna unit.

4. The electronic device as claimed in claim 3, wherein the antenna units further comprise a fourth antenna unit, the guiding through-holes further comprise a fourth guiding through-hole, the fourth antenna unit transmits a fourth wireless signal, the fourth guiding through-hole guides the fourth wireless signal primarily along a fourth axis, the first antenna unit is located between the fourth antenna unit and the third antenna unit, a first included angle is formed between the first axis and the third axis, a second included angle is formed between the fourth axis and the third axis, and the second included angle is not smaller than the first included angle.

5. The electronic device as claimed in claim 4, wherein the antenna units further comprise a fifth antenna unit, the guiding through-holes further comprise a fifth guiding through-hole, the fifth antenna unit transmits a fifth wireless signal, the fifth guiding through-hole guides the fifth wireless signal primarily along a fifth axis, the second antenna unit is located between the fifth antenna unit and the third antenna unit, a third included angle is formed between the second axis and the third axis, a fourth included angle is formed between the fifth axis and the third axis, and the fourth included angle is not smaller than the third included angle.

6. The electronic device as claimed in claim 5, wherein the radiation intensity of the fourth wireless signal is greater than that of the third wireless signal.

7. The electronic device as claimed in claim 6, wherein the radiation intensity of the first wireless signal is greater than or equal to that of the third wireless signal.

8. The electronic device as claimed in claim 7, wherein the radiation intensity of the fifth wireless signal is greater than that of the third wireless signal.

9. The electronic device as claimed in claim 8, wherein the radiation intensity of the second wireless signal is greater than or equal to that of the third wireless signal.

10. The electronic device as claimed in claim 7, further comprising a controller, wherein the controller is coupled to the antenna module, and the controller determines the radiation intensities of the first wireless signal, the second wireless signal, the fourth wireless signal and the fifth wireless signal in every beamforming configuration based on the power density distribution in a near field of every beamforming configuration.

11. The electronic device as claimed in claim 1, wherein the thickness of the guiding structure is between 1.5 mm and 3 mm.

12. The electronic device as claimed in claim 1, further comprising a device housing, wherein the guiding structure is formed on the device housing.

13. The electronic device as claimed in claim 1, wherein a first guiding slope is formed within the first guiding through-hole, and in a vertical projection plane, the first guiding slope partially overlaps the first antenna unit.

14. The electronic device as claimed in claim 13, wherein the antenna units further comprise a third antenna unit, the guiding through-holes further comprise a third guiding through-hole, the third antenna unit transmits a third wireless signal, the third guiding through-hole guides the third wireless signal primarily along the third axis, the third antenna unit is located between the first antenna unit and the second antenna unit, a second guiding slope is formed within the second guiding through-hole, and in the vertical projection plane, the second guiding slope partially overlaps the second antenna unit.
